(19) United States
(12) Patent Application Publication
(10) Pub. No.: US 2021/0300642 A1
(43) Pub. Date: Sep. 30, 2021

(54) System for Identification of Contents in a Closed Container

(71) Applicant: John Seed, Elmvale (CA)

(72) Inventor: John Seed, Elmvale (CA)

(21) Appl. No.: 16/938,252

(22) Filed: Jul. 24, 2020

Related U.S. Application Data
(60) Provisional application No. 62/994,975, filed on Mar. 26, 2020.

(51) Int. Cl. B65D 50/06; B65D 51/22; G01N 1/10

(52) U.S. Cl. CPC B65D 50/062; G01N 2001/1037; G01N 1/10; B65D 51/228

(57) ABSTRACT

This present invention discloses an identification tag for containers for informing a user as to what type of hazardous material is stored in a fuel container. The identification tag for container is a shaped disc inside a tag cover and attached to the container. The identification tag for the containers features a rotating or changeable disc with different labels or regions for the hazardous materials. The device also allows users to set the disc at a specific label and then attach the tag to the container via the clip, and ensures the proper hazardous material type is identified within the container.

### CROSS-REFERENCE TO RELATED APPLICATION

The present application claims priority to, and the benefit of, U.S. Provisional Application No. 62/994,975, which was filed on Mar. 26, 2020 and is incorporated herein by reference in its entirety.

### BACKGROUND

The present invention relates generally to the field of identification of contents of containers, particularly those containing hazardous materials such as benzene, fuel oil, diesel, petroleum products and the like. More specifically, the present invention relates to an identification tag for identifying petroleum products inside a container, thereby notifying a user as to what type of petroleum product is stored in the container to avoid error in use. The invention discloses a method or a system for quick and accurate identification of contents in a closed container. Accordingly, the present specification makes specific reference to the specific embodiments described, however, it is to be appreciated that aspects of the present invention are also equally amenable to other like applications, devices and methods of manufacture.

Typical petroleum product containers have a container body for receiving, storing, transporting, and dispensing petroleum products such as gasoline, diesel, mixed fuel or compressed or other types of fuel. Such containers are generally constructed of metal, plastic, synthetic resin or other similar material and are designed in a way to permit stored petroleum products to be dispensed from an opening at a top of the container for using the fuel. Petroleum product containers are commonly available in standard colors, for example red for flammable liquids such as gasoline, yellow for diesel, blue for kerosene, green for oils and the like. While size of the container may vary, some may have liners in case the external container is punctured.

Existing fuel containers are generally safe and effective for their intended purpose when properly used and cared for. However, such fuel containers are typically opaque and a user is unable to view the content inside the container, particularly if the container also has an internal protective liner. This often leads to confusion and difficulty to the user. Sometimes, the user may confuse the fuel present inside a fuel container and pour the wrong fuel in a machine. If the wrong type of petroleum product is poured into a machine or equipment, serious damage may occur to the machinery or equipment. A wrong judgment is occasionally made by those users who ignore safe practices and instead recklessly pour liquid fuel from a fuel container into a machine, equpment or other place of application such as a home generator. The results of this confusion are predictable and tragic when the petroleum product which is being poured is not the one required by the machine or engine. Further, a need for fuel identification exists in the state of the art, particularly when the user is not utilizing the proper colored container or is using a generic container not specific for any type of petroleum product.

By the way of background, various fuel named stickers are used, which are pasted to a front of the container to identify the petroleum product inside the container. For different petroleum products, different stickers are required and pasted one over the other, for identifying different petroleum products at different times. This degrades the aesthetic look of the container. Further, a user often has to buy all the stickers for identifying different kinds of fuels. Furthermore, once the sticker is used, and another sticker for a different petroleum product is pasted over it, the earlier sticker becomes unusable. Therefore, such stickers are not reusable, and the user has to buy a new sticker in such scenarios, which increases the user's cost. Additionally, it becomes difficult for a user to manage too many stickers and is often frustrating to buy these fuel identification stickers frequently. Moreover as the number of stickers or labels placed on the container builds up, the adhesive of the lower most sticker or label degrades over time and the stack of stickers or labels may fall off due to the failure of the underlying adhesive leaving the user to guess the type of petroleum product within the container.

Another existing solution is the use of fuel identification tags for identifying the petroleum product inside an opaque container. Fuel container labels or tags are a plastic piece with a clip to attach the identification tags to the petroleum product container. Such identification labels can be made up of any suitable material such as polyester fabric, elastomer, etc. The identification labels may be of different colors for different petroleum products and can have petroleum product name etched on such label, for providing a quick and convenient method of petroleum product identification. Such tags can be clipped and unclipped to identify different petroleum products in the container. Although, such identification tags are reusable, the user often has to manage different tags for different petroleum products such as diesel, gasoline, mixed, kerosene, unleaded, and the like, which becomes inconvenient for the user. An improved petroleum product identification method is desired in the state of the art.

Therefore, there exists a long felt need in the art for proper identification of the type of petroleum product stored in a specific container. There is a long felt need in the art for a quick, easy and cost-effective solution for identification of petroleum product in an opaque container. There is also a long felt need in the art for a highly structured identification tag, to notify the user as to what type of petroleum product is stored in a fuel container. There is a long felt need in the art for a reusable tag system, which can be conveniently managed by the user. Additionally, there is a long felt need in the art to provide a single identification tag, to identify different petroleum products such as gasoline, diesel, mixed fuel, or others. Finally, there is a long felt need in the art for an improved petroleum product identification method to ensure that proper petroleum product type is identified within the container for application to or use with various machinery or equipment types.

The subject matter disclosed and claimed herein, in one embodiment thereof, comprises an identification tag for petroleum product containers to notify a user as to what type of petroleum product is stored in a container. The uniquely designed identification tag for petroleum product containers comprises a hexagonal shaped cardboard or paperboard disc placed inside an identification tag cover. Other suitable materials may be used, such as coated paper stock, plastic or the like so long as the material is suitably rigid and printable with the correct indicia. The identification tag is equipped with a metal clip to attach the identification unit to the specific container. The identification tag for petroleum product containers features a rotating or rotatable disc with different labels or regions with each label or region being used to identify a different petroleum product such as gasoline, diesel, mixed fuel, or other customizable labels or regions. The device also allows a user to rotate and set the disc at a specific label or region and then attach the tag to the petroleum product container via the metal clip. The invention ensures that proper petroleum product type is identified within the container for use with the proper equipment or machinery. Further, the identification tag functions as a label or warning indicator and ensures the proper petroleum product type is displayed for easy identification by the user. The disc is rotatable and features several customizable labels or regions such as ‘gasoline’, ‘diesel’ and ‘mixed fuel.’ Further, the labels or regions are customizable and other labels such as kerosene, unleaded, water and others, can also be utilized for identifying different kinds of content stored inside the container. Furthermore, the device is reusable and eliminates confusion when storing different petroleum products in various containers. Users can adjust the hexagonal dial to display the proper fuel type in an easily visible manner. While the examples used herein reference petroleum products, it should be understood that this invention is easily applicable to various chemicals and other materials, fluids, gases or the like which may be stored in a container. In addition, the label or region may also hold date information so that the user is aware when the petroleum products were acquired.

In this manner, the identification tag for petroleum product or other material containers of the present invention accomplishes all of the forgoing objectives, and provides a relatively quick, easy and cost-effective solution to notify the user as to what type of petroleum product is stored in the container. The improved identification tag for petroleum product containers of the present invention ensures the proper petroleum product type is displayed for easy identification. Further, the innovative identification tag is reusable and is therefore, budget-friendly for users. Finally, the improved identification tag for petroleum product containers of the present invention can be used repeatedly and eliminates confusion in storing different petroleum products in various containers.

### SUMMARY

The following presents a simplified summary in order to provide a basic understanding of some aspects of the disclosed innovation. This summary is not an extensive overview, and it is not intended to identify key/critical elements or to delineate the scope thereof. Its sole purpose is to present some concepts in a simplified form as a prelude to the more detailed description that is presented later.

The subject matter disclosed and claimed herein, in one embodiment thereof, comprises an identification tag for petroleum product containers to notify a user as to what type of petroleum product is stored in the container. The identification tag for the petroleum product containers of the present invention features a rotating, rotatable or changeable disc with different labels or regions for identifying different substances such as gasoline, diesel, mixed fuel, or other fluids, gases or materials . The identification tag for the petroleum product containers also allows users to rotate, change and set the disc at a specific label and then attach the tag to a petroleum product container via a clip, and ensure that the proper petroleum product type is identified within the container for use with various machinery or equipment.

The uniquely designed identification tag of the present invention is in one embodiment, a hexagonal-shaped cardboard or paperboard disc placed inside a rigid or protective identification tag cover. The identification tag is equipped with a metal or other suitable material (e.g., a plastic clip) to attach the identification unit to the specific petroleum product container. The identification tag functions as a label or identifier and ensures the proper petroleum product type is displayed for easy identification and use. The identification tag can be of any other shape, such as circular, square, triangular and other shapes offering similar advantages of the invention. The metal clip attached to the identification tag can be made of any other material such as plastic, elastomer, or any other material suitable to the user. The disc is rotatable or changeable and features in one example three different labels, such as “gasoline”, “diesel” and “mixed fuel”, which may be printed at predetermined intervals on the cardboard-based tag. The intervals are aligned with tag cover such that when the disc is rotated, the identifier is visible. Ideally, the disc will also lock in position with a corresponding opening in the tag cover such that the disc will not inadvertently rotate or change, thereby defeating the purpose of the invention. The device is reusable, changeable and eliminates confusion when storing different petroleum products in various containers. Users can adjust the hexagonal dial or disc to display the proper petroleum product type in an easily visible manner.

In yet another embodiment of the present invention, the identification tag includes a rotating disc or dial with more than three labels such as kerosene, unleaded, water, etc. which are customizable and multiple labels can also be included with the disc or dial for identifying different kinds of contents stored inside the container.

In yet another embodiment of the presently described invention, the identification tag is a hexagonal-shaped cardboard or paperboard disc equipped with a rigid clip designed to identify the type of petroleum or other product stored in the specific container. The identification tag functions as a label or identifier and ensures the proper product type is displayed for easy identification. The identification tag can be of any other shape, such as circular, square, triangular, “T” and other shapes offering similar advantages of the invention. The rigid clip attached to the identification tag can be made of any other material such as plastic, elastomer, or any other material suitable to the user so long as the material is sufficiently durable to allow repeated use and application. The disc is rotatable or changeable and features in one embodiment three different labels, regions or identifiers such as for ‘gasoline’, ‘diesel’ and ‘mixed fuel.’ The labels or identifiers can be detachable and can be attached to the rotating discs by any fixing mechanisms, e.g. adhesive, staples, other fasteners or the like. The labels can be changed based on the requirements of the user and the applicability of the product type.

In a further exemplary embodiment of the presently described invention, a hazardous material container is described and includes a container that has a defined volume which is adapted to receive hazardous materials. A disc is provided and has first and second sides with the first side provided with a plurality of regions, with each region having at least one or colors or indicia relating to the hazardous materials. A cover sized and configured to hold the disc, the cover having an opening at one end and an indicia viewing portion, and the cover is attached to the container.

In a still further exemplary embodiment of the presently described invention, a petroleum products container identification system is provided and includes a container manufactured to hold petroleum products. The container has a handle for carrying the container. A cardboard disc is provided with indicia and coloration regions at spaced intervals for designating different petroleum products, with the disc having a geometric shape. A cover is sized and configured to accommodate the geometric shape of the disc, and the cover has an opening for insertion of the disc. The cover further has an indicia viewing region for viewing one of the indicia and coloration regions, and the cover is removably attached to the handle of the container via a clip.

In a further exemplary embodiment of the presently described invention, a method of using a hazardous material identification system is described and includes the steps of initially providing a container with a handle that has been manufactured to hold hazardous materials. Then, an identification disc is produced with the identification disc having a plurality of regions with each region having at least one of a color or indicia relating to the hazardous materials to be held in the container. The identification disc preferably has a geometric shape. Next, a cover is provided and sized and configured to hold the identification disc. The cover has an opening and a viewing area. The identification disc is inserted in the cover through the opening such that one of the regions is visible through the viewing area. Then, the cover with the identification disc is attached to the container by a removable clip.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and is intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a perspective view of one possible embodiment of identification tag fixed to the handle of a petroleum product container of the present invention in accordance with the disclosed structure;

FIG. 2(a) illustrates a perspective view of one possible embodiment of the rotating hexagonal disc of the present invention in accordance with the disclosed structure

FIG. 2(b) illustrates a perspective view of one possible embodiment of an identification tag cover of the present invention in accordance with the disclosed structure;

FIG. 2(c) illustrates a perspective view of one possible embodiment of a clip for use with the system of the present invention in accordance with the disclosed structure; and

FIG. 3 illustrates one possible embodiment of insertion of the labeled disc inside the identification tag cover of the present invention in accordance with the disclosed structure.

### DETAILED DESCRIPTION

The innovation is now described with reference to the drawings, wherein like reference numerals are used to refer to like elements throughout. In the following description, for purposes of explanation, numerous specific details are set forth in order to provide a thorough understanding thereof. It may be evident, however, that the innovation can be practiced without these specific details. In other instances, well-known structures and devices are shown in block diagram form in order to facilitate a description thereof.

As noted above, there exists a long felt need in the art for proper identification of the type of petroleum product stored in a specific container. There is a long felt need in the art for a quick, easy and cost-effective solution for identification of petroleum product in an opaque container. There is also a long felt need in the art for a highly structured identification tag, to notify the user as to what type of petroleum product is stored in a container, particularly when a generic type container is used. There is a long felt need in the art for a reusable tag system, which can be conveniently managed and changed by the user. Additionally, there is a long felt need in the art to provide a single identification tag, to identify different petroleum products such as gasoline, diesel, mixed fuel, or others. Finally, there is a long felt need in the art for an improved petroleum product identification method to ensure that proper petroleum product type is identified within the container for use with various type of machinery or equipment.

The innovative product of the present invention features an identification tag for petroleum product containers to notify the user as to what type of petroleum product is stored in the container. The uniquely designed identification tag for petroleum product containers includes a hexagonal shaped cardboard or paperboard disc placed inside a rigid identification tag cover. The identification tag is equipped with a rigid clip to attach the identification unit to the specific container. The identification tag for petroleum product containers also allows users to rotate, change and set the cardboard disc at a specific label or indicator and then attach the tag to the container via the clip, and ensure that the proper petroleum product type is identified within the container for use with various types of equipment or machinery.

In a most preferred embodiment, the identification tag for petroleum product containers of the present invention is a hexagonal or other shaped cardboard disc equipped with a rigid clip designed to identify the type of product stored in a specific container. The identification tag can be of any other shape, such as circular, square, diamond, triangular, “T” and other shapes offering similar advantages of the invention. A clip attached to the identification tag can be made of any other material such as metal, plastic, elastomer, coated board stock or any other material suitable to the use of the present invention. The identification tag for containers functions as a label and ensures the proper petroleum product type is displayed for easy identification. The disc is rotatable or changeable and features for example, three customizable labels, regions or identifiers such as “gasoline”, “diesel” and “mixed fuel”. In an alternate embodiment, the identification tag includes a rotating disc or placard with more than three labels such as kerosene, unleaded, water, etc. which are customizable and multiple labels can also be included with the tag for identifying different kinds of contents stored inside the container.

In another embodiment of the present invention, the rotating or changeable disc can be made of any other material such as metal and other durable materials, particularly those that can withstand the petroleum products or other chemicals with which the tag may come into contact with. Also, the labels may be printed or etched on the rotating disc. Further, the labels can be a detachable piece, which can be changed by the user as per the requirements and applicability of the identification tag unit or as may be required by applicable legislation or regulatory requirements.

The uniquely designed identification tag device is a single device capable of displaying and identifying different types of products by using the device. Further, the device is reusable and eliminates confusion while storing different fuels in various containers. Users can adjust the shaped dial as per the requirements of the contents, to display the required product stored in the container in an easily visible manner.

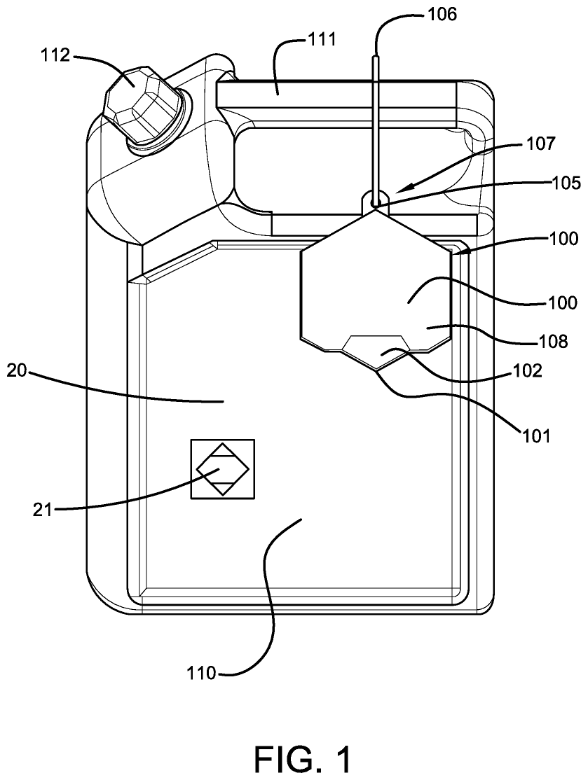

Referring initially to the drawings, FIG. 1 illustrates a perspective view of one possible embodiment of identification tag fixed to the handle of a fuel container of the presently described invention in accordance with the disclosed structure. The identification tag 100 has an outer housing or an identification tag cover 108 and an insert in a form of a rotatable cardboard or paperboard disc 101. In a preferred embodiment, the cardboard disc 101 is of hexagonal shape, however other shapes such as circular, diamond, triangular, square, pentagon, star, heptagon, octagon, oval, circular including other non-geometric shapes such as a “T” shape are also possible with the same invention. Further, the disc 101 can be made of any material such as cardboard, metal, coated paperboard, plastic, tag stock, and other durable materials that are capable of withstanding exposure to petroleum products, chemicals and any vapors emitted by such materials. The cardboard disc 101 contains in the present example three customizable labels such as gasoline label 102, diesel label 103 and mixed fuel label 104. Additionally, more than three labels can be provided on the disc 101 to identify different product types. The identification tag structure 100 is equipped with a clip 106 and includes a hole or an opening 105 on the identification tag cover 108 to allow the clip 106 to be inserted inside the hole.

In an alternative embodiment, as shown in FIG. 1 the tag 100 may be inserted into a plastic, transparent pocket 120 on the side of the container to allow the disc 101 to be visible through the pocket. The pocket 120 may be secured to the outside of the 110 by adhesive, bonding or other suitable means which holds the pocket permanently to the container.

The clip 106 attaches the tag 100 to a container 110. The clip 106 inserts through the hole 105 present in a top panel 107 of the identification tag 100 and is hung from a handle 111 of the container 110. The container 110 is also provided with a cap 112 which covers an opening in the fuel container 110 provided to transfer the petroleum product or other material into or out of the container 110. The identification tag 100 for containers 110 of the present invention can be of any suitable size and measurement which allows ease in visibility, reading the label and at the same time can be attached to most commonly used container handles 111. However, the exact size, measurement, construction, and design specifications may vary upon further development and manufacturing. Each region, label or indicator on the disc 101 is preferably provided with the color associated with the petroleum product, for example, red for gasoline, blue for kerosene, green for oils, yellow for diesel, etc. In addition, to the color provided on the disc, each region may also include the indicia relating to the color, for example, a yellow coloration would include the word “diesel”, red coloration would include the word “gasoline” and the like. The identification tag 100 of this presently described invention may be manufactured from any sheet material of suitable strength such as, for example, paper, cardboard, coated paperboard, tag stock, aluminum, copper, etc., but the preferable material in accordance with the present invention is cardboard material. Cardboard material or wax coated cardboard of predefined thickness gives sufficient strength to the product 100 to withstand the abuse encountered in product transfer operation.

Cardboard or paperboard liners weights suitable for use with the present invention range from about 115 to 300 grams per square meter (“GSM”) with about 140 to 200 GSM being preferred. Corrugated carboard is preferred and is typically made up of two liners, plus an internal single fluting or undulating later. This structure is known as a “single wall” board. Such single walled materials have a thickness ranging from 3.5 to 4.0 mm. Double walled or triple walled material may also be suitable and would include more than one fluting layer and have a thickness ranging from 4.0 mm to 7.6 mm. Increasing the number of walls increases the thickness of the material and would generally require a large outer tag covering. The most common weight for the fluting layer ranges from 90 to 150 GSM with about 105 GSM being the most preferred. The tag of the present invention may be made from recycled material or any combination of virgin and post-consumer waste to help decrease cost as well as to provide an environmental benefit. The cardboard of the presently described tag may also contain a wax or polyethylene coating to prevent corrosive effects of the products in the container. Cardboard suitable for use in this application is manufactured according to ASTM D4727.

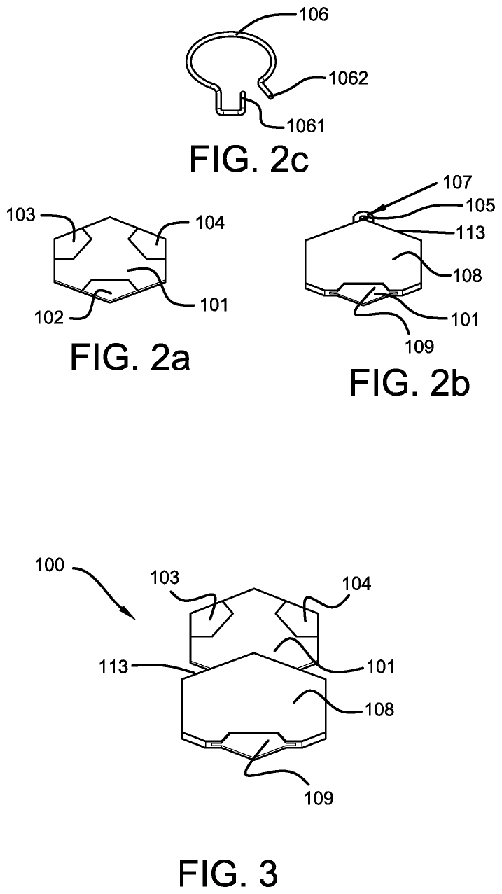

FIGS. 2(a), (b) and (c) collectively illustrates an exploded view of one possible embodiment of identification tag for a container suitable for holding hazardous materials such as petroleum products and includes a rotatable or movable disc, a clip and an identification tag cover of the present invention in accordance with the disclosed structure. FIG. 2(a) discloses a hexagonal shaped disc 101 including labels for Gasoline 102, Diesel 103 and Mixed Fuel 104 on a front surface of the disc 101. In addition to the printed indicia the corresponding designated color is also provided in the corresponding area of the disc 101 which is printed on a first side 121. The disc 101 has a second side (not shown) which may have identical indicia provided thereon. The disc 101 is preferably made up of cardboard, however, other durable materials such as metal, fiber, polycarbonate, industrial plastic and the like can also be utilized to manufacture the disc 101. Further, the disc can be of any shape such as circular, diamond, triangular, square, pentagon, and the like. The disc 101 is rotatable and can be easily rotated or changed by a user. As shown in the FIG. 2(a), the disc 100 comprises three different labels, 102, 103 and 104. However, the invention is not limited and may include any number of labels to identify different fuels.

FIG. 2(b) discloses an identification tag cover 108 having a label cut-out or viewing portion 109 to display the required fuel label 102, 103 or 104 provided on the disc 101. The identification tag cover 108 includes a top panel 107 provided at an upper portion of the identification tag cover 108, which further includes a hole 105 for inserting a clip 106. A joint edge on the top panel 107 and the identification tag cover 108 comprises an upper slit 113, which allows the disc 101 to be inserted inside the cover 108 and removed therefrom. The tag cover 108 as depicted is of a hexagonal shape to accommodate the hexagonal shaped rotatable disc 101. Typically, the tag cover 108 is of the shape of the label disc 101, and can be of different shapes such as circular, diamond, triangular, square, pentagon, heptagon, and the like. The tag cover 108 can be manufactured using any material such as cardboard, metal and other durable materials. The tag cover 108 can be of any suitable color, print or any customized advertising label, or the like.

FIG. 2(c) discloses a rigid clip 106 having a first end 1061 and a second end 1062. The first end 1061 is inserted in the hole 105 provided on the top panel 107 of the tag cover 108. Further, the second end 1062 of the clip 106 is inserted through the handle 111 of the fuel container 110, and is joined and locked to the first 1061, in order to attach the identification tag 100 to the fuel container 110. The clip 106 is preferably made up of metal, and can be manufactured using other materials such as plastic, and other durable materials. Clip 106 may be any fastening mechanism known in the art including, without limitation, a string, a chain, a strap and the like, that can be utilized to attach the identification tag 100 to the fuel container 110. The clip 106 can of any shape such as oval, circular, etc. and of any color as suitable to the user.

In an embodiment of the present invention, the hexagonal cardboard disc 101 is equipped with the metal clip 106 designed to identify the type of fuel stored in a specific fuel container 110. The identification tag 100 functions as a label and ensures the proper product type, such as petroleum product is displayed for easy identification. The disc 101 is rotatable or changeable and features several customizable labels such as a gasoline label 102, diesel label 103, mixed fuel label 104, and other suitable labels as may be required. The identification tag 100 is reusable and eliminates confusion when storing different fuels in various fuel containers 110, particularly when the containers are generic containers. Users can adjust the hexagonal disc 101 to display the proper fuel type in an easily visible manner.

In the most preferred embodiment of the present invention, a hole 105 is located on a top panel 107 of the identification tag 100 through which a metal clip 106 is threaded for effective attachment of the identification tag 100 to the fuel container's handle 111.

FIG. 3 illustrates one possible embodiment of insertion of the labeled disc 101 inside the identification tag cover 108 of the present invention in accordance with the disclosed structure. The disc 101 can be inserted inside the tag cover 108 of the identification tag 100 through the slit 113. The disc 101 is rotatable, prior to insertion and features several customizable labels such as gasoline label 102 (not shown), diesel label 103, mixed fuel label 104. An indicia viewing portion 109 in the identification tag cover 108 allows the label, color and/or indicia to be displayed and visible to the user. The cut out portion also serves to lock the disc in position so that the disc does not move while inserted into the cover. The label 102, 103 or 104 is generally a name of the product that is present in the container 110. The identification tag 100 is reusable and eliminates confusion when storing different fuels in various fuel containers 110. Users can adjust the hexagonal disc 101 to display the proper fuel type in an easily visible manner.

One main advantage of the identification tag 100 of this invention is the ease with which it is applied to any container 110. The unique and innovative design allows the identification tag 100 to be quickly and easily attached to a clip 106 with the help of a hole 105 present in a top panel 107 of the identification tag cover 108. Therefore, the identification tag 100 may be placed on or hung from the fuel container 110 very easily. Further, the single device 100 fulfils the user requirements of identifying different types of hazardous products in the container 110, without managing multiple tag devices. Furthermore, the hazardous product identification tag 100 provides a convenient, quick, reusable and cost-effective solution for the users.

Thus, it should be apparent that a solution has been provided, in accordance with the present invention, in the form of an identification tag 100 for a petroleum product container 110 that fully satisfies the objectives and advantages set forth above. Users can happily and easily use the identification tag 100 for the container 110 to know about the hazardous products, such as petroleum based products stored inside the container 110.

The use of the fuel identification tags 100 has been described for the identification of the petroleum product present in a container 110 to which the identification tags 100 may be attached. Thus, it is to be understood that these identification tags 100 may be altered in design to adapt to their attachment mechanisms such as metal clips, thread, string, wire, or heavy cord, and the like. Further, it is to be understood that these identification tags 100 are applicable to all types of containers 110, such as a gasoline container, a mixed fuel container, a diesel container, chemical container or any other container which may be used for transporting hazardous materials. The invention is not restricted to the identification of fuels, and may be applicable to other areas where an identification tag would be required to identity different kinds of materials stored in the containers.

Certain terms are used throughout the following description and claims to refer to particular features or components. As one skilled in the art will appreciate, different persons may refer to the same feature or component by different names. This document does not intend to distinguish between components or features that differ in name but not structure or function. As used herein “identification tag”, “identification device”, and “fuel identification tag” are interchangeable and refer to the fuel identification tag assembly 100 of the present invention.

Notwithstanding the forgoing, the fuel identification tag 100 of the present invention and its various structural components can be any suitable size, shape, and configuration as is known in the art without affecting the overall concept of the invention, provided that it accomplishes the above stated objectives. One of ordinary skill in the art will appreciate that the shape and size of the fuel identification tag 100 and its various components, as show in the FIGS. are for illustrative purposes only, and that many other shapes and sizes of the fuel identification tag 100 are well within the scope of the present disclosure. Although dimensions of the fuel identification tag 100 and its components are important design parameters for good performance, the fuel identification tag 100 and its components may be any shape or size that ensures optimal performance during use and/or that suits user need and/or preference.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A hazardous material container, comprising;
a container having a defined volume and adapted to receive hazardous materials;
a disc having first and second sides with the first side provided with a plurality of regions with each region having at least one of colors or indicia relating to the hazardous materials; and
a cover sized and configured to hold the disc, the cover having an opening at one end and an indicia viewing portion, and the cover is attached to the container.

2. A hazardous material container as recited in claim 1, wherein the disc is constructed from one of cardboard, paperboard, waxed paperboard, waxed cardboard or combinations thereof

3. A hazardous material container as recited in claim 1, wherein the disc is printed with both indicia and color in each region of the disc.

4. A hazardous material container as recited in claim 1, wherein the disc is selected from a shape including circular, diamond, triangular, square, pentagon, star, heptagon, octagon, oval, circular or “T” shape.

5. A hazardous material container as recited in claim 4, wherein the cover has a substantially similar shape to that of the disc.

6. A hazardous material container as recited in claim 1, wherein the indicia viewing portion is at an opposite end of the opening.

7. A hazardous material container as recited in claim 1, wherein the indicia viewing portions locks a region of the disc in a viewing position to view the at least one of indicia or color.

8. A hazardous material container as recited in claim 1, wherein the disc is hexagonally shaped and is provided with three regions equally spaced from one another.

9. A hazardous material container as recited in claim 1, wherein the hazardous materials are petroleum based products.

10. A hazardous material container as recited in claim 9, wherein the petroleum based products are gasoline, diesel, kerosene and oil.

11. A hazardous material container as recited in claim 1, wherein the cover is attached to the container via a removable clip.

12. A hazardous material container as recited in claim 1, wherein the cover is attached to the container via a transparent pocket which is permanently secured to the container.

13. A hazardous material container as recited in claim 2, wherein the disc has a weight of material of between about 115 to 300 grams per square meter and a thickness of between 3.5 mm to 7.6 mm.

14. A petroleum products container identification system, comprising;
a container manufactured to hold petroleum products, the container having a handle for carrying the container;
a cardboard disc provided with indicia and coloration regions at spaced intervals for designating different petroleum products, the disc has a geometric shape;
a cover sized and configured to accommodate the geometric shape of the disc, the cover having an opening for insertion of the disc and an indicia viewing region for viewing one of the indicia and coloration regions, and the cover is removably attached to the handle of the container via a clip.

15. A petroleum products container identification system as recited in claim 14, wherein the cardboard disc has a weight of material of between about 115 to 300 grams per square meter and a thickness of between 3.5 mm to 7.6 mm.

16. A petroleum products container identification system as recited in claim 14, wherein the petroleum products are gasoline, diesel, kerosene and oil.

17. A petroleum products container identification system as recited in claim 14, wherein the disc is hexagonally shaped and is provided with three regions equally spaced from one another.

18. A petroleum products container identification system as recited in claim 14, wherein the indicia viewing portions lock a region of the disc in a viewing position to view one of the indicia or coloration regions.

19. A method of using a hazardous material identification system, comprising the steps of;
providing a container manufactured to hold hazardous materials, the container having a handle for holding and carrying the container;
producing an identification disc, the identification disc having plural regions with each region having at least one of a color or indicia relating to the hazardous materials to be held in the container; the identification disc having a geometric shape;
providing a cover sized and configured to hold the identification disc, the cover having an opening and a viewing area;
inserting the identification disc in the cover through the opening such that one of the regions is visible through the viewing area; and
attaching the cover with the identification disc to the container by a removable clip.

20. A method as recited in claim 19, wherein the identification disc is constructed of cardboard and has a weight of material of between about 115 to 300 grams per square meter and a thickness of between 3.5 mm to 7.6 mm.
